(19) United States
(12) Patent Application Publication
(10) Pub. No.: US 2007/0005380 A1
(43) Pub. Date: Jan. 4, 2007

(54) System and method for determining a lifecycle stage of a corporation using quantitative measures

(75) Inventors: Barbara Jean Vivier, Niskayuna, NY (US); Benjamin Thomas Verschueren, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/170,683

(22) Filed: Jun. 29, 2005

(51) Int. Cl. G06Q 99/00

(52) U.S. Cl. 705/1

(57) ABSTRACT

A system for determining the lifecycle stage of a corporation using quantitative measures is provided. The system comprises a lifecycle model definition component. The lifecycle model definition component is configured to define one or more lifecycle models. Each lifecycle model is associated with a set of quantitative measures and a set of rules. The system further comprises a lifecycle stage inference component and a lifecycle stage determination component. The lifecycle stage inference component is configured to infer a particular lifecycle stage for the corporation based on the set of quantitative measures and the set of rules associated with each lifecycle model. The lifecycle stage determination component is configured to combine the inferences made by the lifecycle inference component to determine an overall lifecycle stage for the corporation.

### BACKGROUND

The invention relates generally to lifecycle stage analysis for a corporation and more particularly to a system and method for determining the lifecycle stage of a corporation using quantitative measures.

Corporations typically experience multiple stages in their lifecycle. A corporation, or more generally a business entity, is typically characterized according to a sequence of lifecycle stages, such as: startup or early growth; growth; maturity or stability; and decline. The particular lifecycle stage of a corporation reflects the behavior and risks associated with the corporation during that particular stage.

Determining the current and historical stages of a corporation provides an important insight to decision makers such as investors and commercial lending institutions. Investors interpret financial data in the context of the corporation's lifecycle stage since expectations for financial results differ across stages. Commercial lending institutions infer the financial health of a corporation and its likelihood of successful operation, resulting in its ability to repay its debt, based on its lifecycle stage. Knowing that a corporation is in a growth stage rather than in a decline stage influences a decision maker in one corporation to invest in another corporation or even whether to merge with or to acquire another corporation.

Various approaches to determine the lifecycle stage of a corporation have been used in the past by financial analyzers. This characterization has largely been performed using qualitative indicators associated with the business entity, information about the organizational structure of the corporation, best practices followed by the corporation and by conducting interviews. Qualitative indicators may include, for example, business event data that reflect certain behavioral symptoms or catalysts of financial stress associated with the corporation.

The corporation is then assessed as being in a particular stage in its lifecycle based upon the interviews and the qualitative indicators and in some cases the corporation's own assessment of its stage. Subsequently, a “quantitative characterization” of the lifecycle stage of the corporation may be performed, using the analysis of the qualitative assessment. That is, financial and other quantitative characteristics associated with the business entity, such as, for example, age, annual sales, growth, net income and cash flow may be used to interpret the corporation's financial data in the context of its lifecycle stage.

A challenge faced with determining and assessing the lifecycle stage of a corporation using the above approach is that the analysis relies largely upon the particular expertise of well-trained individuals. In addition, the use of qualitative indicators involves the manual collection and assimilation of vast amounts of information. This collection of such vast amounts of information is not standardized, not subject to the rigor of statistical analysis, and is not a scalable technique, particularly when lifecycle stage analysis has to be performed for large sets of corporations.

While the various previous approaches to determine the lifecycle stage of a corporation have focused on determining the lifecycle stage using qualitative measures, it would be desirable to establish a set of quantitative measures that infer and define a corporation's lifecycle stage, rather than to use the set of quantitative measures to describe a corporation whose lifecycle stage is already known. Accordingly, there is a need for a technique to infer and identify the lifecycle stage of a corporation using quantitative characteristics associated with the corporation.

### BRIEF DESCRIPTION

Embodiments of the present invention address this and other needs. In one embodiment a system for determining the lifecycle stage of a corporation using quantitative measures is provided. The system comprises a lifecycle model definition component. The lifecycle model definition component is configured to define one or more lifecycle models. Each lifecycle model is associated with a set of quantitative measures and a set of rules. The system further comprises a lifecycle stage inference component and a lifecycle stage determination component. The lifecycle stage inference component is configured to infer a particular lifecycle stage for the corporation based on the set of quantitative measures and the set of rules associated with each lifecycle model. The lifecycle stage determination component is configured to combine the inferences made by the lifecycle inference component to determine an overall lifecycle stage for the corporation.

In another embodiment, a method for determining the lifecycle stage of a corporation using quantitative measures is provided. The method comprises defining one or more lifecycle models. Each lifecycle model is associated with a set of quantitative measures and a set of rules. The method further comprises inferring a particular lifecycle stage for the corporation based on the set of quantitative measures and the set of rules associated with each lifecycle model. Finally, the method comprises combining the inferences of the lifecycle stages for the corporation to determine an overall lifecycle stage for the corporation.

### DRAWINGS

These and other features, aspects, and advantages of the present invention will become better understood when the following detailed description is read with reference to the accompanying drawings in which like characters represent like parts throughout the drawings, wherein:

FIG. 1 is an illustration of a high-level architecture diagram of a system for determining the lifecycle stage of a corporation using quantitative measures; and

FIG. 2 is a flowchart illustrating exemplary steps for determining the lifecycle of a corporation using quantitative measures.

### DETAILED DESCRIPTION

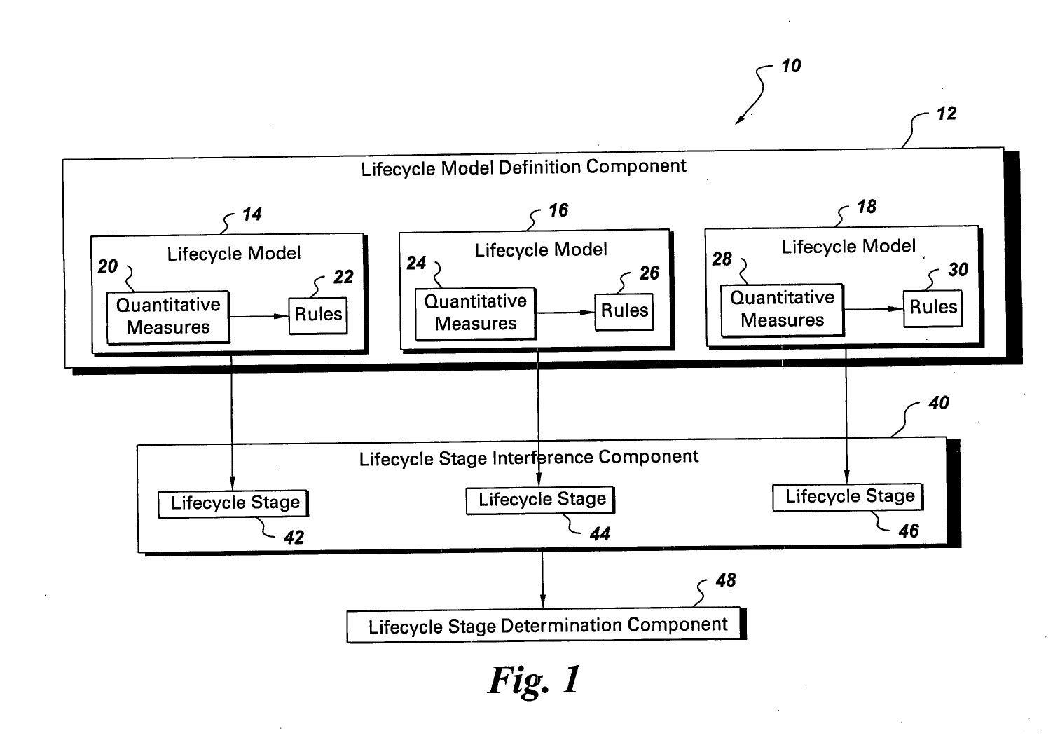

FIG. 1 is an illustration of a high-level architecture diagram of a system for determining the lifecycle stage of a corporation using quantitative measures. As shown in FIG. 1, the system 10 includes a lifecycle model definition component 12, a lifecycle stage inference component 40 and a lifecycle stage determination component 48.

Referring to FIG. 1, the lifecycle model definition component 12 includes one or more lifecycle models, represented generally by the reference numerals 14, 16 and 18. In a particular embodiment of present invention, and as shown in FIG. 1, each lifecycle model 14, 16 and 18 is defined by a set of quantitative measures and a set of rules. In accordance with the present embodiment, and as will be described in greater detail below, multiple rules may comprise the set of rules and each rule in the set of rules includes a condition, which when satisfied, contributes to determining a particular lifecycle stage for the corporation.

Referring again to FIG. 1, the life cycle model 14, for example, is defined by a first set of quantitative measures, 20 and an associated set of rules 22. In one embodiment of the present invention, the first set of quantitative measures 20 includes the “age” of the corporation, the “total revenue growth” of the corporation and an inflation rate. As used herein, the “age” of the corporation refers to the age of the corporation in years and the “total revenue growth” of the corporation refers to the compound annual growth rate of the corporation's revenues. One of ordinary skill in the art will recognize that “age,” “total revenue growth” and “inflation rate” are exemplary examples of quantitative measures and are not meant to limit other examples of quantitative measures that may be associated with the lifecycle model 14.

In an exemplary embodiment of the present invention, the set of rules 22 are implemented as a set of “if-then” rules, as illustrated in Table-1 below:

TABLE 1

| Model Stage | Rules |
|---|---|
| Young | Age is less than five years |
| Growth | 1) Total Revenue Growth is greater than 50% |
| | 2) Total Revenue Growth is greater than |
| | zero and number of corporations in this |
| | corporation's SIC code is greater than or |
| | equal to 10 and the total revenue growth |
| | is in the top 10% of those in the SIC |
| Stability | Age is greater than or equal to five years |
| | and total revenue growth is not equal to zero. |
| Decline | Total growth is less than inflation rate. |

Referring to Table-1 above, the SIC code refers to the Standard Industrial Classification (SIC) Code indicating the corporation's line of business. In a particular embodiment, the set of rules 22 may be implemented using Statistical Analysis Software (SAS) programs. However, a number of other statistical analysis techniques and toolkits may also be used to implement the above rules such as, for example, programming languages such as Java or C++ or artificial intelligence-based expert system environments.

The lifecycle stage inference component 40 is then configured to infer a particular lifecycle stage 42 for the corporation based on the set of quantitative measures 20 and the set of rules 22 associated with the lifecycle model 14.

For example, an inference of a particular lifecycle stage 42 for the corporation based on the set of quantitative measures 20 and the set of rules 22 defined by the lifecycle model 14 may be made by the lifecycle stage inference component 40 as follows. Referring to Table-i above, a “young” stage for a corporation is inferred if the corporation is less than five years old; a “growth” stage is inferred if the “total revenue growth” of the corporation is more that 50%; and a “decline” stage is inferred if the corporation is growing less than the rate of inflation. Further, as mazy be observed, the set of rules 22 includes a condition that changes some of the “stability” stages of a corporation into “growth” stages, if the corporation ranks in the top 10% of companies in the industry 2-digit SIC code for a given quarter. Else, the corporation is inferred to be in a “stability” stage if it is at least five years old and has a certain value for the total revenue growth.

In an alternate embodiment of the present invention, one or more additional lifecycle models, such as, for example, 16 and 18 defined in the lifecycle model definition component 12 may also be used to provide assessments of the lifecycle stage for the same corporation at the same point in time.

As shown in FIG. 1, the lifecycle model 16 is associated with a second set of quantitative measures 24 and an associated set of rules 26. In a particular embodiment, the second set of quantitative measures 24 includes the “net income” (NI), “cash flow from operations” (CFO), “cash flow from investments” (CFI), and “cash flow from financing” (CFF) associated with the corporation. One of ordinary skill in the art will recognize that the above quantitative measures of NI, CFO, CFI and CFF are exemplary examples of quantitative measures and are not meant to limit other examples of quantitative measures that may be defined by the lifecycle model 16. In a particular embodiment, the lifecycle model 16 is a model proposed by the Anderson School of Management. As will be appreciated by those skilled in the art, the lifecycle model proposed by the Anderson School of Management generally includes four stages, “Young”, “Growth”, “Stability” and “Decline”.

The set of rules 26 are defined by a set of conditions about net income (NI), cash flow from operations (CFO), cash flow from investments (CFI), and cash flow from financing (CFF), and are illustrated in Table-2 below:

TABLE 2

| Rule Condition: | Vote: |
|---|---|
| NI small or NI negative | Young |
| CFO negative | Young |
| CFI negative | Young |
| CFF positive | Young |
| NI positive | Growth |
| CFO less than NI | Growth |
| CFI negative | Growth |
| CFF positive or zero | Growth |
| NI positive | Stability |
| CFO greater than NI | Stability |
| CFI negative or zero | Stability |
| CFF negative | Stability |
| NI and CFO positive and almost equal | Decline |
| CFI positive | Decline |
| CFF negative | Decline |

As may be observed from Table-2 above, the net income for a corporation is often negative during the “young” lifecycle stage because initial expenses for a young corporation often exceed its revenues. However, negative net income, can be a concern when it occurs at a later stage in the lifecycle. Similarly, a growing corporation has positive cash flow from operations (CFO) but uses its cash for capital expenditures and investments (CFI<0) and raises cash by financing (CFF>0) whereas a stable corporation has more cash than its income, may or may not be acquiring additional assets or businesses (CFI=0 or CFI>0) and may be returning cash to investors to reduce its debt (CFF<0). Investment cash flow turns positive (CFI>0) when a corporation no longer invests in its future, and financing cash flow turns negative (CFF<0) when a corporation does not reduce its debt. Taken together, these two signs may indicate a corporation's decline.

The lifecycle stage inference component 40 may then be used to infer a particular lifecycle stage 44 for the corporation based on the set of quantitative measures 24 and the set of rules 26 as follows. In a particular implementation of the present embodiment, the lifecycle stage inference component applies a voting mechanism to the set of rules 26 to infer the lifecycle stage of the corporation. In accordance with this embodiment, the voting mechanism infers a particular stage for a corporation if a stage receives at least some minimum number of votes, e.g., three. For example, if at least three of the individual rules in the set of rules 26 that would indicate a “young” corporation are satisfied, then the voting mechanism assigns the lifecycle stage of “young.” However, if two stages receive a maximum number of votes (that is, at least three votes), the voting mechanism resolves the tie by using a further set of rules that distinguish between the tied stages, as discussed below. In a further implementation of the present embodiment, these distinguishing cases may be implemented as a set of “if-then” rules and are summarized as shown in Table-3 below:

TABLE 3

| Rule Condition: | Stage |
|---|---|
| (max = vote1 = vote3) and (NI < 0 and | Young |
| CFF > 0) | |
| (max = vote1 = vote2) and (NI < 0) | Young |
| (max = vote1 = vote2) and (NI > 0) | Growth |
| (max = vote2 = vote3) and (CFO < NI | Growth |
| and CFF >= 0) | |
| (max = vote1 = vote3) and (NI > 0 and | Stability |
| CFF < 0) | |
| (max = vote2 = vote3) and (CFO > NI | Stability |
| and CFF < 0) | |
| (max = vote3 = vote4) and (CFI <= 0) | Stability |
| (max = vote3 = vote4) and (CFI > 0) | Decline |
| (max = vote1 = vote2 = vote3) | Stage cannot |
| | be determined |

As used herein “max” refers to the maximum number of votes, vote1 refers to the number of votes received for the “young” stage, vote2 refers to the number of votes received for the “growth” stage, vote3 refers to the number of votes received for the “stability” stage and vote4 refers to the number of votes received for the “decline” stage.

Referring again to the voting mechanism illustrated in Table-3 above, if a tie between the “young” stage and the “stability” stage of the corporation, for example, is observed (that is, both these stages receive a maximum number of votes), the voting mechanism infers that a corporation is in a “young” stage provided that the net income is positive and the “cash flow from financing” is also positive. It may also be observed from the set of rules 26, illustrated in Table-3 above, that the final “else” clause refers to an exemplary situation when a tie cannot be resolved. In the example shown in Table-3, the “final” else clause refers to a situation when three stages are tied. In this case, the set of rules 26 does not determine any stage for that year and quarter for the corporation.

In a further aspect of the present invention, the lifecycle stage inference component 40 may produce another inference, 46, of the lifecycle stage for the corporation at the same point in time based on another set of quantitative measures 28 and an associated set of rules 30 as defined by the lifecycle model 18. The quantitative measures 28 may include, for example, the size of the corporation, the age of the corporation and the employee growth rate of the corporation. Again, one of ordinary skill in the art will recognize that the above quantitative measures are exemplary and are not meant to limit other examples of quantitative measures that may be defined by the lifecycle model 18.

As may be observed from the above discussion, each lifecycle model is associated with a set of quantitative measures and a set of rules and the lifecycle stage inference component produces an assessment or inference of the lifecycle stage for a given corporation at a given point in time based on the set of quantitative measures and the set of rules.

The lifecycle stage determination component 48 is then configured to combine the inferences 42, 44 and 46 made by the lifecycle stage inference component 40 to determine an overall lifecycle stage for the corporation. In a particular embodiment, the lifecycle stage inferences for a corporation may be compared against each other. In certain cases, the result of the inferences made by the lifecycle stage inference component may be in agreement. In cases, where the results vary, the differences may be resolved by a simple majority or by the use of confidence weights associated with each inference. For example, if there are three lifecycle models and the lifecycle stage inference component 40 infers a “young” lifecycle stage for a corporation based on the quantitative measures and the sets of rules from two of the lifecycle models, then the lifecycle stage determination component 48 may determine that the corporation is at the “young” stage. In certain other embodiments, a confidence weight may be assigned to each of the inferences from the lifecycle stage inference component 40. The final determination of the lifecycle stage for the corporation could be an ordered set of stage weights, each with an associated confidence. For example, in a particular embodiment, the lifecycle stage determination component 48 may assign confidence values of {“young”@67%, “growth”@33%} for inferences that have equal weights for each stage and confidence values of {“young”@80%, “growth”@20 %} for inferences that produce different weights for each stage. In other embodiments, differences in lifecycle stage inferences for a corporation may also be resolved by considering the life cycle determinations in the recent past or near future for the corporation with an assumption that large discontinuities do not occur or by favoring “growth” or “stability” over “young” for older corporations and “stability” over “decline” unless the inference is made by a highly reliable lifecycle model.

The use of multiple lifecycle models, coupled with the use of financial and other quantitative data produces an objective assessment of the lifecycle stage of a corporation across a large number of time periods. A consensus among the different inferences of the lifecycle stages of a corporation strengthens the belief in the determination of the lifecycle stage while differences of opinion may be used to identify corporations and time periods for more careful assessment.

In an alternate embodiment of the present invention, the lifecycle stage determination component 48 may be further configured to evaluate a corporation based on its determined lifecycle stage or evaluate the determined lifecycle stage of the corporation in comparison with similar lifecycle stages of one or more industrial segments related to the corporation. In addition, the lifecycle stage determination component 48 may be configured to combine the lifecycle stage of a plurality of corporations to determine the lifecycle stage of an industrial segment representative of the plurality of corporations. In a further aspect of the present embodiment, the lifecycle stage determination component 48 may also be configured to compare the determined lifecycle stage of the corporation to one or more industrial segments related to the corporation with respect to whether the corporation leads or lags with respect to the one or more industrial segments related to the corporation. In certain embodiments, after determining the lifecycle stages for corporations, the lifecycle stage determination component 48 may cluster the corporations using Standard SIC codes, for example. Averaging techniques may then be used for each time period to produce a lifecycle stage determination for the overall cluster. Where the cluster represents an industry, an investment risk application may benefit from knowing the life cycle stage of an industry. In addition, a risk manager may want to know if an industry is stable rather than declining. In certain other embodiments, the lifecycle stage determination component 48 may compare the lifecycle stage of the cluster to each individual corporation in the cluster to determine if the corporation is consistent or inconsistent with that cluster. Such insight may allow for the identification of a growing corporation in an otherwise stable or declining industry.

In a particular embodiment of the present invention, two or more datasets (not shown in FIG. 1) may be used to evaluate the results from the lifecycle stage inference component 40. In a particular embodiment, the datasets include corporations with a record of bankruptcy or default (defaulted corporations) and corporations without any such record (non-defaulted corporations). In accordance with a particular embodiment, the lifecycle stage determination component 48 may examine the differences between the lifecycle stages of defaulted and non-defaulted corporations to determine whether the existence of a corporation in a particular lifecycle stage is an indication of a corporate default. In the case of defaulted corporations, the lifecycle stage determination component 48 may determine that a corporation is defaulting when it occurs during or shortly after a “decline” life cycle stage. In addition, knowing that a corporation is in a “decline” stage may also support applications that predict corporate bankruptcy.

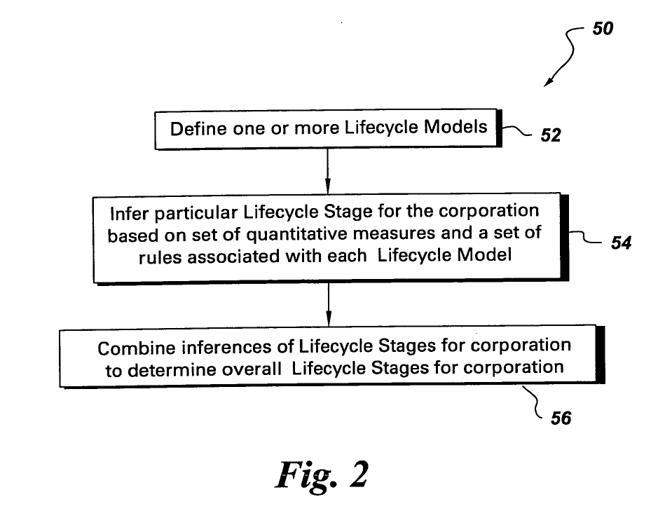

FIG. 2 is a flowchart illustrating exemplary steps for determining the lifecycle stage of a corporation using quantitative measures. In step 52, one or more lifecycle models are defined. As described above, each lifecycle model is associated with a set of quantitative measures and a set of rules. In step 54, a particular lifecycle stage for the corporation is inferred based on the set of quantitative measures and the set of rules associated with each lifecycle model. As mentioned above, the lifecycle stages may include the “young,” “growth,” “stability,” and “decline” stages. In particular, and as mentioned above, the quantitative measures and rules from each lifecycle model are used to produce an assessment or inference of the lifecycle stage for a given corporation at a given point in time. In step 56, the inferences of the lifecycle stages for the corporation are combined to determine an overall lifecycle stage of the corporation at a given point in time.

As will be appreciated by those skilled in the art, the embodiments and applications illustrated and described above will typically include or be performed by appropriate executable code in a programmed computer. Such programming will comprise a listing of executable instructions for implementing logical functions. The listing can be embodied in any computer-readable medium for use by or in connection with a computer-based system that can retrieve, process and execute the instructions. Alternatively, some or all of the processing may be performed remotely by additional computing resources based upon raw or partially processed image data.

In the context of the present technique, the computer-readable medium is any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable media can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for determining the lifecycle stage of a corporation using quantitative measures, the system comprising:
a lifecycle model definition component configured to define one or more lifecycle models, wherein each lifecycle model is associated with a set of quantitative measures and a set of rules;
a lifecycle stage inference component configured to infer a particular lifecycle stage for the corporation based on the set of quantitative measures and the set of rules associated with each lifecycle model; and
a lifecycle stage determination component configured to combine the inferences made by the lifecycle inference component to determine an overall lifecycle stage for the corporation.

2. The system of claim 1, wherein the set of quantitative measures comprise net income, cash flow from operations, cash flow from investments and cash flow from financing associated with the corporation.

3. The system of claim 1, wherein the set of quantitative measures comprise size of the corporation, age of the corporation and the employee growth rate of the corporation.

4. The system of claim 1, wherein the set of quantitative measures comprise age of the corporation, total revenue growth of the corporation and an inflation rate.

5. The system of claim 1, wherein the lifecycle stage determination component is further configured to compare the inferences made by the lifecycle stage inference component prior to combining.

6. The system of claim 1, wherein the lifecycle stage determination component is configured to evaluate the corporation based on its lifecycle stage.

7. The system of claim 1, wherein the lifecycle stage determination component is further configured to evaluate the lifecycle stage of the corporation in comparison with similar lifecycle stages of one or more industrial segments related to the corporation.

8. The system of claim 1, wherein the lifecycle stage determination component is configured to determine the lifecycle stages of a plurality of corporations and combine the determined lifecycle stages of the plurality of corporations to determine the lifecycle stage of an industrial segment representative of the plurality of corporations.

9. The system of claim 1, wherein the lifecycle stage determination component is configured to use the determined lifecycle stage of the corporation to compare the corporation to one or more industrial segments related to the corporation with respect to whether the corporation leads or lags with respect to the one or more industrial segments related to the corporation.

10. A method for determining the lifecycle stage of a corporation using quantitative measures, the method comprising:
defining one or more lifecycle models, wherein each lifecycle model is associated with a set of quantitative measures and a set of rules;
inferring a particular lifecycle stage for the corporation based on the set of quantitative measures and the set of rules associated with each lifecycle model; and
combining the inferences of the lifecycle stages for the corporation to determine an overall lifecycle stage for the corporation.

11. The method of claim 10, wherein the set of quantitative measures comprise net income, cash flow from operations, cash flow from investments and cash flow from financing associated with the corporation.

12. The method of claim 10, wherein the set of quantitative measures comprise size of the corporation, age of the corporation and the employee growth rate of the corporation.

13. The method of claim 10, wherein the set of quantitative measures comprise age of the corporation, total revenue growth of the corporation and an inflation rate.

14. The method of claim 10, further comprising comparing the inferences of the lifecycle stages for the corporation prior to combining.

15. The method of claim 10, further comprising evaluating the corporation based on its lifecycle stage.

16. The method of claim 10, further comprising evaluating the lifecycle stage of the corporation in comparison with similar lifecycle stages of one or more industrial segments related to the corporation.

17. The method of claim 10, further comprising determining the lifecycle stage of a plurality of corporations and combining the determined lifecycle stages of the plurality of corporations to determine the lifecycle stage of an industrial segment representative of the plurality of corporations.

18. The method of claim 10, further comprising using the determined lifecycle stage of the corporation to compare the corporation to one or more industrial segments related to the corporation with respect to whether the corporation leads or lags with respect to the one or more industrial segments related to the corporation.

19. At least one computer-readable medium storing computer instructions for instructing a computer system for determining the lifecycle stage of a corporation using quantitative measures, the computer instructions comprising:
defining one or more lifecycle models, wherein each lifecycle model is associated with a set of quantitative measures and a set of rules;
inferring a particular lifecycle stage for the corporation based on the set of quantitative measures and the set of rules associated with each lifecycle model; and
combining the inferences of the lifecycle stages for the corporation to determine an overall lifecycle stage for the corporation.
